(19) United States
(12) Patent Application Publication
(10) Pub. No.: US 2011/0250453 A1
(43) Pub. Date: Oct. 13, 2011

(54) PHOTONIC CRYSTALS COMPOSED OF POLYMER PARTICLES WITH INTERPARTICULATE INTERACTION

(75) Inventors: Reinhold Leyrer, Dannstadt-Schauernheim (DE); Wendel Wohlleben, Mannheim (DE)

(73) Assignee: BASF SE, Ludwigshafen (DE)

(21) Appl. No.: 12/675,039

(22) PCT Filed: Aug. 22, 2008
(86) PCT No.: PCT/EP08/61002

§ 371 Date: Feb. 24, 2010

(30) Foreign Application Priority Data
Aug. 24, 2007 (EP) 07114965.2

(51) Int. Cl. C08F 257/02; C08F 220/58; C08F 220/18; C08F 212/36; B32B 5/16; C08F 220/28

(52) U.S. Cl. 428/402; 525/296; 525/303; 525/309

(57) ABSTRACT

What is described is the use of polymer particles for producing photonic crystals, wherein the polymer particles do not film and have, at their contact points in the photonic crystal, linkage sites which allow linkage of the particles by physical or chemical bonding, without reducing the volume of the interstitial phase by more than 30%.

The invention relates to the use of polymer particles with interparticulate interaction for producing photonic crystals, and to photonic crystals obtainable by virtue of this use.

A photonic crystal consists of periodically arranged dielectric structures which influence the spread of electromagnetic waves. Compared to normal crystals, the periodic structures have such orders of magnitude that interactions with electromagnetic radiation of high wavelength occur, and thus optical effects in the region of UV light, of visible light, of IR radiation or even microwave radiation can be made utilizable for industrial purposes.

Synthetic polymers have already been used to produce photonic crystals. EP-A-955 323 and DE-A-102 45 848 disclose the use of emulsion polymers with a core/shell structure. The core/shell particles are filmed, the outer soft shell forming a matrix in which the solid core is incorporated. The lattice structure is formed by the cores; after the filming, the shell serves merely to fix the structure.

Chad E. Reese and Sandford A. Asher, Journal of Colloid and Interface Science 248, 41-46 (2002) disclose the use of large, charged polymer particles for producing photonic crystals. The polymer used consists of styrene and hydroxyethyl acrylate (HEA). The potassium persulfate used as an initiator also reacts with HEA, as a result of which the desired ionic groups form.

The preparation of large polymer particles from polymethyl methacrylate is described in EP-A-1 046 658; use for producing photonic crystals is not mentioned.

European patent application 06123516.4, which has an earlier priority date but had not been published at the priority date of the present application, relates to photonic crystals composed of uncharged polymer particles which preferably comprise no ionic groups and preferably no polar groups either. The polymer particles have no linkage sites at their contact points.

For many applications, very large photonic crystals are desired. A prerequisite for very good optical properties is a very well-defined, i.e. substantially ideal, lattice structure over the entire photonic crystal.

It was therefore an object of the present invention to provide large photonic crystals with good optical properties and polymer particles suitable for their production.

The object is achieved in accordance with the invention by the use of polymer particles for producing photonic crystals, in which the polymer particles do not film and have, at their contact points in the photonic crystal, linkage sites which allow linkage of the particles by physical or chemical bonding, without reducing the volume of the interstitial phase by more than 10%.

The object is additionally achieved by structured or unstructured photonic crystals which are obtained using the aforementioned polymer particles.

The object is additionally achieved by a process for producing the structured or unstructured photonic crystals, in which the photonic crystals are formed from an aqueous dispersion of the polymer particles by volatilization of the water.

The invention additionally relates to the use of the structured or unstructured photonic crystals for producing templates, as optical components or for producing optical components.

The polymer particles used in accordance with the invention have linkage sites at their contact points in the photonic crystal. Linkage sites need not be present at all contact points. Linkage sites are present preferably at at least 40%, more preferably at at least 60%, especially at at least 80%, most preferably at at least 90%, of the contact points in the photonic crystal.

The linkage by physical or chemical bonding is effected such that the volume of the interstitial phase is reduced by not more than 30%, preferably not more than 10%, including zero. More preferably, the volume of the interstitial phase is reduced by not more than 5%, especially by not more than 2%. It is desired in accordance with the invention to reduce the volume of the interstitial phase as little as possible. A reduction is effected, for example, by matrix formation as described in DE-A-102 45 848.

The interstitial phase refers to the remaining cavities in the photonic crystal which form after the formation of the photonic crystal from an aqueous dispersion of the polymer particles by volatilization of the water. According to the invention, it is preferred that the linkage of the particles does not cause any significant reduction in these cavities, in order that they are subsequently available in their entirety for production of an inorganic photonic crystal.

It is preferred in one embodiment of the invention that the particles are linked by chemical covalent bonding, ionic or polar bonding, hydrogen bonding, van der Waals bonding or interdiffusion.

It is preferred in one embodiment of the invention that the polymer particles have a weight-average particle size of >600 nm.

It is preferred in one embodiment of the invention that the polydispersity index, as a measure of the uniformity of the polymer particles, is <0.15, where the polydispersity index is calculated by the formula p.i.=(D90−D10)/D50 in which D90, D10 and D50 denote particle diameters for which:
D90: 90% by weight of the total mass of all particles has a particle diameter<or =D90
D50: 50% by weight of the total mass of all particles has a particle diameter≦D50
D10: 10% by weight of the total mass of all particles has a particle diameter<or =D10.

It is preferred in one embodiment of the invention that the polymer particles, at least at the contact points, have polymers attached by polymerization on their surface, which can diffuse into one another and whose glass transition temperature is below the crystallization temperature of the photonic crystal.

It is preferred in one embodiment of the invention that the polymer particles have, at least at the contact points on their surface, polar groups or groups suitable for forming hydrogen bonds, which enable linkage in the course of crystallization of the photonic crystal.

It is preferred in one embodiment of the invention that the chemical covalent bonding is achieved by virtue of the polymer particles having, at least at the contact points, chemical groups which are bonded to the polymer particle and can be bonded covalently to one another at ambient temperature thermally, by redox reaction, photochemically, if appropriate also using photoactivable initiators or catalysts and/or by means of an additional crosslinker.

It is preferred in one embodiment of the invention that the polymer particles have, at least at the contact points, chemical groups which are bonded to the polymer and can enter into ionic, polar, van der Waals or hydrogen bonds with one another or via an additional suitable crosslinker.

It is preferred in one embodiment of the invention that the polymer particles, at least in the core, consist of monovalent hydrocarbon monomers to an extent of more than 70% by weight, preferably to an extent of more than 90% by weight, and of crosslinking monomers to an extent of from 0 to 30% by weight, preferably of 0 to 10% by weight.

It is preferred in one embodiment of the invention that the polymer particles consist of styrene to an extent of more than 90% by weight and the crosslinker is divinylbenzene.

It is preferred in one embodiment of the invention that the polymer particles form the lattice structure of the photonic crystal, without being embedded into a liquid or solid matrix.

It is preferred in one embodiment of the invention that the polymer particles have a weight-average particle size of greater than 900 nm.

It is preferred in one embodiment of the invention that the polydispersity index, as a measure of the uniformity of the polymer particles, is less than 0.10.

It is preferred in one embodiment of the invention that no surface-active assistants which are used to disperse polymer particles in water are present on the surface of the polymer particles.

It is preferred in one embodiment of the invention that the monomers of which the polymer particles consist are present in uncharged form in the polymer particle.

It is preferred in one embodiment of the invention that the polymer particles, at least in the core, consist of crosslinking monomers (crosslinkers) to an extent of from 0.01% by weight to 10% by weight, preferably to an extent of 0.1% by weight to 3% by weight.

It is preferred in one embodiment of the invention that the polymer particles, at least in the core, have a glass transition temperature above 50° C., preferably above 80° C.

It is preferred in one embodiment of the invention that the polymer particles are produced by an emulsifier-free or emulsifier-containing emulsion polymerization.

It is preferred in one embodiment of the invention that the polymer particles are produced by emulsifier-free or emulsifier-containing emulsion polymerization and salt agglomeration.

It is preferred in one embodiment of the invention that the polymer particles are produced by emulsifier-free or emulsifier-containing emulsion polymerization and swelling polymerization.

It is preferred in one embodiment of the invention that the polymer particles are produced by emulsifier-free or emulsifier-containing emulsion polymerization, salt agglomeration and swelling polymerization.

It is preferred in one embodiment of the invention that the swelling polymerization too is emulsifier-free or emulsifier-containing.

It is preferred in one embodiment of the invention that the swelling polymerization is undertaken in at least two stages (swelling stages).

It is preferred in one embodiment of the invention that the polymer or the polymer particles is/are crosslinked, and the crosslinker is added in the last swelling stage in the preparation.

In one embodiment of the invention, the photonic crystals preferably have a particle separation, based on the center of the particles, of >600 nm, more preferably >900 nm.

In one embodiment of the invention, preference is given to photonic crystals having at least one edge length of >200 μm, preferably >500 μm, more preferably greater than 2 mm.

In the production of templates, it is preferred in one embodiment to use the photonic crystals for producing templates with defined defect structures.

The Polymer Particles

For the inventive use, the polymer particles should have a suitable size, and all polymer particles should be substantially homogeneous, i.e. ideally have exactly the same size.

The particle size and the particle size distribution can be determined in a manner known per se, for example with an analytical ultracentrifuge (W. Machtle, Makromolekulare Chemie 185 (1984) page 1025-1039), and the D10, D50 and D90 value can be taken therefrom and the polydispersity index can be determined; the values and data in the description and in the examples are based on this method.

A further method of determining the particle size and the particle size distribution is hydrodynamic fractionation (HDF).

The measurement configuration of HDF consists of a PSDA Particle Size Distribution Analyzer from Polymer Labs. The parameters are as follows: a type 2 cartridge (standard) is used. The measurement temperature is 23.0° C., the measurement time 480 seconds, the wavelength of the UV detector 254 nm. In this method too, the D10, D50 and D90 values are taken from the distribution curve and the polydispersity index is determined.

The D50 value of the particle size distribution corresponds to the weight-average particle size; 50% by weight of the total mass of all particles have a particle diameter less than or equal to D50.

The weight-average particle size is preferably greater than 900 nm.

The polydispersity index is a measure of the homogeneity of the polymer particles; it is calculated by the formula

P.I.=(D90−D10)/D50

where D90, D10 and D50 denote particle diameters for which:

D90: 90% by weight of the total mass of all particles has a particle diameter less than or equal to D90

D50: 50% by weight of the total mass of all particles has a particle diameter less than or equal to D50

D10: 10% by weight of the total mass of all particles has a particle diameter less than or equal to D10.

The polydispersity index is preferably less than 0.15, more preferably less than 0.10, most preferably less than 0.06.

In processes for emulsion polymerization, the hydrophobic monomers to be polymerized are emulsified in water with the aid of a surface-active compound, e.g. an emulsifier or a protective colloid, and then polymerized. After the polymerization, the surface-active compound is present on the surface of the resulting polymer particles distributed in the aqueous dispersion. Even after the removal of the water and formation of a polymer film, these compounds remain as additives in the polymer.

In the polymer particles used in accordance with the invention, it is optionally possible for no such surface-active assistants to be present on the surface. As early as in the production of the polymer particles, it is possible to dispense with surface-active assistants.

The linkage sites at the contact points of the polymer particles may be provided in different ways, for example by surface functionalization of the polymer particles. The core of the polymer particle can be constructed as described below. The functionalization may be present at different points on the core surface, or else in the form of a shell around the core. However, it is not necessary in accordance with the invention that the core is completely surrounded by a shell comprising the functionalization. The degree of functionalization should preferably be such that the aforementioned proportions of linkage points are present.

The core polymer preferably consists to an extent of more than 90% of hydrophobic monomers which comprise no ionic groups and preferably no polar groups either.

Most preferably, the core polymer consists to an extent of more than 90% by weight of hydrocarbon monomers, i.e. of monomers which comprise no atoms other than carbon and hydrogen.

More preferably, the core polymer consists to an extent of more than 90% by weight, more preferably to an extent of more than 95% by weight, of styrene.

The core polymer is, or the core polymer particles are, preferably at least partly crosslinked.

The core polymer or the core polymer particles consist(s) of crosslinking monomers (crosslinkers) preferably to an extent of from 0.01% by weight to 10% by weight, more preferably to an extent of 0.1% by weight to 3% by weight.

The crosslinkers are especially monomers having at least two, preferably two, copolymerizable, ethylenically unsaturated groups. One useful example is divinylbenzene.

The core polymer has, or the core polymer particles have, preferably a glass transition temperature above 50° C., preferably above 80° C.

In the context of the present application, the glass transition temperature is calculated by the Fox equation from the glass transition temperature of the homopolymers of the monomers present in the copolymer and their proportion by weight:

1/Tg=xA/TgA+xB/TgB+xC/TgC+

Tg: calculated glass transition temperature of the copolymer

TgA: glass transition temperature of the homopolymer of monomer A

TgB, TgC correspondingly for monomers B, C, etc.

xA: mass of monomer A/total mass of copolymer,

xB, xC correspondingly for monomers B, C etc.

The Fox equation is stated in customary textbooks, for example also in Handbook of Polymer Science and Technology, New York, 1989 by Marcel Dekker, Inc.

The Preparation of the Polymer

The preparation is effected preferably by emulsion polymerization.

If the polymer particles are not to comprise any surface-active assistants on the surface, the preparation is more preferably effected by emulsifier-free emulsion polymerization.

In emulsifier-free emulsion polymerization, the monomers are dispersed and stabilized in water without surface-active assistants; this is effected especially by intensive stirring. Otherwise, emulsifiers are employed, as described in the prior art mentioned at the outset.

The emulsion polymerization is effected generally at from 30 to 150° C., preferably from 50 to 100° C. The polymerization medium may consist either only of water or of mixtures of water and liquids miscible with it, such as methanol. Preference is given to using only water. The feed process can be carried out in staged or gradient mode. Preference is given to the feed process in which a portion of the polymerization mixture is initially charged, heated to the polymerization temperature and polymerized partly, and then the rest of the polymerization mixture is fed to the polymerization zone continuously, in stages or with superimposition of a concentration gradient, while maintaining the polymerization, typically via several spatially separate feeds, of which one or more comprise(s) the monomers in pure form. In the polymerization, it is also possible to initially charge a polymer seed, for example for better establishment of the particle size.

The manner in which the initiator is added to the polymerization vessel in the course of the free-radical aqueous emulsion polymerization is known to the average person skilled in the art. It can either be initially charged in the polymerization vessel in its entirety or used continuously or in stages according to its consumption in the course of the free-radical aqueous emulsion polymerization. Specifically, this depends on the chemical nature of the initiator system, and also on the polymerization temperature. Preference is given to initially charging a portion and supplying the remainder to the polymerization zone according to the consumption.

A portion of the monomers can, if desired, be initially charged in the polymerization vessel at the start of the polymerization; the remaining monomers, or all monomers when no monomers are initially charged, are added in the course of the polymerization in the feed process.

The regulator too, if it is used, can be partly initially charged, or added entirely or partly during the polymerization or toward the end of the polymerization.

By virtue of the inventive emulsion polymerization, for example emulsifier-free emulsion polymerization, stable emulsions of large polymer particles are obtainable.

Further measures which increase the mean particle diameter are known. Useful measures include especially salt agglomeration, for example emulsifier-free salt agglomeration, or swelling polymerization, for example emulsifier-free swelling polymerization.

In the salt agglomeration process, dissolved salts bring about agglomeration of polymer particles and thus lead to a particle enlargement.

Preference is given to combining emulsion polymerization, for example emulsifier-free emulsion polymerization, with salt agglomeration; the polymer particles are therefore preferably produced by emulsion polymerization, for example emulsifier-free emulsion polymerization, and salt agglomeration.

The salt is preferably already dissolved in water at the start of the emulsion polymerization, such that the agglomeration commences already at the start of the emulsion polymerization, and the resulting agglomerated polymer particles then grow uniformly during the emulsion polymerization.

The salt concentration is preferably from 0.5 to 4% based on the polymer to be agglomerated, or from 0.05% to 0.5% based on the water or solvent used.

Useful salts include all water-soluble salts, for example the chlorides or sulfates of the alkali metals or alkaline earth metals.

The emulsion polymerization, for example emulsifier-free emulsion polymerization, can also be combined with a swelling polymerization. In the swelling polymerization, further monomers are added to an already obtained aqueous polymer dispersion (1st stage for short), preferably obtained by emulsion polymerization, for example emulsifier-free emulsion polymerization, and the polymerization of these monomers (2nd stage or swelling stage) is commenced only once these monomers have diffused into the polymer particles already present and the polymer particles have swollen.

In the 1st stage, preferably from 5 to 50% by weight, more preferably from 10 to 30% by weight, of all monomers from which the polymer is or the polymer particles are formed are polymerized by emulsion polymerization, for example emulsifier-free emulsion polymerization. The remaining monomers are polymerized in the swelling stage. The amount of the monomers in the swelling stage is several times the amount of the monomer used in the first stage, for example from two to ten times, more preferably from three to five times.

The swelling polymerization too can be effected without emulsifier.

In particular, the monomers are supplied to the swelling stage only when the monomers of the 1st stage have polymerized to an extent of at least 80% by weight, especially to an extent of at least 90% by weight.

A feature of the swelling polymerization is that the polymerization of the monomers is commenced only after completion of swelling.

Therefore, during and after the addition of the monomers of the swelling stage, preferably no initiator is added. When initiator is added or initiator is present in the polymerization vessel, the temperature is kept sufficiently low that no polymerization proceeds. The polymerization of the monomers of the swelling stage is carried out only after completion of swelling by adding the initiator and/or increasing the temperature. This may be the case, for example, after a period of at least half an hour after the addition of the monomers has ended. The monomers of the swelling stage are then polymerized, which leads to a stable particle enlargement.

The swelling polymerization can especially also be undertaken in at least two stages (swelling stages), more preferably from 2 to 10 swelling stages. In each swelling stage, the monomers to be polymerized are supplied, swollen and then polymerized; polymerization of the monomers is followed by the addition and swelling of the monomers of the next swelling stage with subsequent polymerization, etc. Preferably, all monomers which are to be polymerized by swelling polymerization are distributed uniformly between the swelling stages.

In a preferred embodiment, the polymer is or the polymer particles are crosslinked, for which a crosslinking monomer (crosslinker) is also used (see above). Preferably, the crosslinker is not added and polymerized until the swelling polymerization, more preferably in that of the last swelling stage.

In a particular embodiment, the polymer particles are therefore produced by emulsion polymerization, for example emulsifier-free emulsion polymerization, followed by swelling polymerization.

Particular preference is given to the combination of the emulsion polymerization, for example emulsifier-free emulsion polymerization, with salt agglomeration, as described above, and subsequent swelling polymerization.

Linkage of the Particles

By virtue of the inventive functional surface, the polymer particles do not deform, but, even without matrix formation, have a very stable, hard contact area to one another, such that they are not deformed. At the same time, no intermediate layer is required to produce the particles, which significantly simplifies the production process. According to the invention, it is possible to modify the polymer particles to increase the stability of the crystal in such a way that they can enter into physical or chemical bonds at the contact sites, without any need to apply a shell of a modified polymer. It thus becomes possible to achieve a high mechanical stability of the organic crystal in the production of the photonic crystals by inversion with inorganic materials such as TiO₂ or Si. To produce the inverse structure, no precursors are used in the particle.

The bonding of the polymer particles at the contact points can be effected by physical and chemical bonding, preferably by chemical covalent bonding, ionic or polar bonding, hydrogen bonding, van der Waals bonding or interdiffusion.

Interdiffusion is achieved especially by polymerizing polymers whose glass transition temperature is below the crystallization temperature of the photonic crystal onto the particles. For example, it is possible to polymerize acrylates having a low glass transition temperature onto a polystyrene core. A particularly suitable acrylate is n- or tert-butyl acrylate. The proportion of the diffusible polymer in overall polymer particles is preferably from 1 to 30% by weight. The application is possible, for example, by swelling polymerization. The amount applied is adjusted such that no matrix formation occurs in the interdiffusion, such that the volume of the interstitial phase is not reduced.

In another embodiment of the invention, the polymer particles have, at least at the contact points on their surface, polar groups or groups suitable for forming hydrogen bonds, which enable linkage in the course of crystallization of the photonic crystal. For example, butanediol monoacrylate can be applied to the surface in order to obtain a polar surface.

Polar groups are preferably provided by hydroxyl groups. Hydrogen bonds between the polymer particles are preferably generated by hydroxyl groups and acid groups.

The physical interactions can be brought about as early as in the course of drying of the dispersion at ambient temperature or lower temperatures, without an additional heat treatment step at higher temperatures being required. Typically, the physical interaction should occur even at temperatures in the range from 10 to 30° C. In other cases, it is also possible to carry out heat treatment at elevated temperatures, for example in the range from 30 to 50° C.

The bonding is effected preferably by means of a chemical covalent bond when a particularly high bond strength is desired. In this case, the interparticulate interaction is preferably achieved by reactive groups which bring about a chemical interaction or crosslinking. It is particularly suitable to use N-methylolmethacrylamide (MAMOL) or N-methylolacrylamide (AMOL). These reactive monomers are preferably bonded to the particulate core (for example by swelling polymerization) and subsequently converted by redox reaction or thermally or during the drying process, if appropriate even at room temperature, in the course of production of the crystal. Acrylic acid groups can crosslink by heat treatment at elevated temperature in the range from 50 to 100° C. via anhydride formation. Maleic anhydride formation is also possible. In addition, additional crosslinkers such as aminomethylsilane may be used in the serum of the dispersion for additional stabilization. Such crosslinkers may also have been attached to the glass substrate beforehand in the course of production of the photonic crystals.

In the case of use of tert-butyl acrylate, which is hydrophobic per se, chemical attachment to the surface can be achieved. Subsequent isobutene removal can release the hydrophilic, bound acrylic acid, which can crosslink, for example, by salt formation (with Zn) or anhydride formation. It is also possible to use an acrylic acid-containing dispersion for this purpose.

tert-Butyl acrylate may also be added as a dispersion, in which case the hydrophobic particle accumulates on the polymer particles or penetrates into them. The Zn salt crosslinking leads to elevated stability in organic solvents, even without heat treatment.

Instead of acrylic acid for salt binding, it is also possible to use maleic anhydride. Preferred salt formation is effected with Zn(NH₃)₄(HCO₃)₂. Suitable amounts for use are known to those skilled in the art or can be determined by simple experiments.

It is also possible for diacetoneacrylamide (DAAM) to be present in the particle and adipic dihydrazide (ADDH) in the serum, as a result of which dihydrazone formation and hence interparticulate crosslinking at room temperature are possible without heat treatment. Polymer particles which have free hydroxyl groups can be reacted with melamine-formaldehyde oligomers in the serum (for example Luwipal®, especially of types 063, 072, 073 and 069), in which case chemical interparticulate crosslinking is effected. The amount of modifying compounds is preferably from 0.01 to 30% by weight, more preferably from 0.5 to 10% by weight, based on the overall polymer particles.

The use of hydroxyethyl acrylate (HEA), hydroxypropyl acrylate (HPA), of acrylic anhydride and maleic anhydride, blended with disodium tetraborate, leads to interparticulate crosslinking without heat treatment.

In one embodiment of the invention, preferred dispersions for photonic crystals are those which can be crosslinked in an interparticulate manner by UV irradiation or can be structured by three-dimensional imagewise illumination. In this case, it is possible, for example, for cavities or lines to be bombarded out of the structure. The structuring should be finer than the wavelength of the (IR) light in the later use as an optical element.

One example of a crosslinker dissolved in the serum of the dispersion is trimethylolpropane tri(ethoxyacrylate) (Laromer® 8863) using the UV initiator from Ciba Specialty Chemicals Irgacure 500. The UV-activated crosslinking by irradiation of the photonic crystal with UV light likewise leads to interparticulate crosslinking and to an increased stability of the crystal. Preference is given to using such UV-activated crosslinking systems in an amount of from 0.01 to 20% by weight, preferably in an amount of from 0.1 to 10% by weight, more preferably in an amount of from 0.5 to 5% by weight, based on the polymer particles.

Irgacure 500 comprises 50% 1-hydroxycyclohexyl phenyl ketone and 50% benzophenone.

It is also possible to provide dispersion particles having epoxide groups on the surface, which are induced to crosslink in an interparticulate manner by a UV-activable acid donor as a catalyst or by a UV-activable cationic initiator. UV-activable acid donors may especially be iodonium salts or sulfonium salts, which are used in an amount of from 0.01 to 20% by weight, preferably in an amount of from 0.1 to 10% by weight, more preferably in an amount of from 0.5 to 5% by weight, based on the polymer particles. The proportion of epoxide groups, based on the overall polymer particles, is preferably from 0.1 to 30% by weight, more preferably from 1 to 10% by weight.

When tert-butyl acrylate groups are used on the surface of the polymer particles, it is possible to add a UV-activable acid donor, which brings about the catalytic degradation of the tert-butyl acrylate to acrylic acid in the photonic crystal produced from the dispersion. The UV-illuminated sites are then soluble and can be leached out with an aqueous sodium hydroxide solution. These cavities can be filled with high-refractive index materials such as TiO₂ or silicon, such that an inverse, three-dimensionally structured photonic crystal forms.

Overall, it should be noted that a continuous shell around the polymer particles is not necessary, but rather point-by-point presence of the reactive components is sufficient. The bonding forces between the polymer particles must be sufficiently great that the capillary pressure in the course of drying of the crystal and the softening of the particles by melting point depression are exceeded by the bonding forces.

The Production of the Photonic Crystals

To produce photonic crystals, the aqueous polymer dispersions obtained in the above-described preparation processes are preferably used.

The solids content of the aqueous polymer dispersions for this purpose is preferably from 0.01 to 60% by weight, more preferably from 0.1 to 30% by weight, most preferably from 0.5 to 10% by weight. To this end, the polymer dispersions prepared as described above, which are preferably synthesized with a solids content of from 30 to 60%, are generally diluted with demineralized water.

The photonic crystals are preferably formed on a suitable support. Suitable supports are substrates composed of glass, composed of silicon, composed of natural or synthetic polymers, composed of metal or any other materials. The polymers should adhere very strongly on the support surface. The support surface is therefore preferably pretreated chemically or physically in order to obtain good wetting and good adhesion. The surface may, for example, be pretreated by corona discharge, be coated with adhesion promoters or be hydrophilized by treatment with an oxidizing agent, e.g. H₂O₂/H₂SO₄.

The temperature of the polymer dispersion and of the support in the formation of the photonic crystals is preferably in the range from 15 to 70° C., more preferably from 15 to 40° C., especially room temperature (from 18 to 25° C.). The temperature is especially below the melting point and below the glass transition temperature of the polymer.

The photonic crystals are produced from the aqueous dispersion of the polymer particles, preferably by volatilization of the water.

The support and the polymer dispersion are contacted.

The aqueous polymer dispersion can be coated onto the horizontal support, and the photonic crystal forms when the water is volatilized.

The support is preferably immersed at least partly into the dilute polymer dispersion. As a result of evaporation of the water, the meniscus falls and the photonic crystal forms on the formerly wetted sites on the support.

At an angle between support and the liquid surface unequal to 90°, the crystalline order is improved significantly, especially in the case of particles above 600 nm. At a crystallization angle of from 50° to 70°, the best crystalline order is achieved.

In a particular embodiment, support and polymer dispersion can be moved mechanically relative to one another, preferably at speeds of from 0.05 to 5 mm/hour, more preferably of from 0.1 to 2 mm/hour. To this end, the immersed support can be pulled slowly out of the aqueous polymer dispersion, and/or the polymer dispersion can be let out of the vessel, for example by pumping.

The polymer particles are arranged in the photonic crystals according to a lattice structure. The distances between the particles correspond to mean particle diameters. The particle size (see above) and hence also the particle separation, based on the center of the particles, is preferably greater than 600 nm, preferentially greater than 900 nm.

The order, i.e. lattice structure, is formed in the course of the aforementioned preparation. In particular, an fcc lattice structure (fcc=face-centered cubic) with hexagonal symmetry in the crystal planes parallel to the surface of the support is formed.

The photonic crystals obtainable in accordance with the invention have a very high crystalline order, i.e. preferably less than 10%, more preferably below 5%, most preferably below 2%, of the area of each crystal plane has a different crystalline orientation from the rest of the crystal or no crystalline orientation at all, and there are hardly any defect sites; in particular, the proportion of defect sites or different order is therefore less than 2%, or 0%, based on the area in question. The crystalline order can be detected microscopically, especially by atomic force microscopy. In this method, the uppermost layer of the photonic crystal is considered; the above percentages for the maximum proportion of defect sites therefore apply especially to this uppermost layer. The interstices between the polymer particles are empty, i.e. they comprise air if anything.

The resulting photonic crystals preferably exhibit a decline in the transmission (stop band) at wavelengths greater than or equal to 1400 nm (at particle diameter 600 nm), more preferably greater than or equal to 2330 nm (at particle diameter 1000 nm).

According to the invention, it is possible to obtain photonic crystals whose regions of uniform crystal order, in at least one three-dimensional direction, have a length of more than 100 μm, more preferably more than 200 μm, even more preferably more than 500 μm, especially from 1 mm to 20 mm.

The photonic crystals more preferably have at least one length, more preferably both one length and one width, of greater than 200 μm, in particular greater than 500 μm, especially from 1 mm to 20 mm.

The thickness of the photonic crystals is preferably greater than 10 μm, more preferably greater than 30 μm.

The Use of the Photonic Crystals

The photonic crystal can be used as a template for producing an inverse photonic crystal. To this end, the cavities between the polymer particles are filled by known processes with the desired materials, for example with silicon, and then the polymer particles are removed, for example by melting and leaching-out or burning-out at high temperatures. The resulting template has the corresponding inverse lattice order of the preceding photonic crystal.

The photonic crystal or the inverse photonic crystal produced therefrom is suitable as an optical component. When defects are written into the inventive photonic crystal, for example with the aid of a laser or of a 2-photon laser arrangement or of a holographic laser arrangement, and the inverse photonic crystal is produced therefrom, both this modified photonic crystal and the corresponding structured inverse photonic crystal can be used as electronic optical components, for example as multiplexer or as optical semiconductors. Thermal structuring or else UV structuring is possible.

The photonic crystal, or the cavities of the colloid crystal, can be used for infiltration of inorganic or organic substances.

The invention is illustrated in detail by the examples which follow.

### EXAMPLES

Abbreviations used:

NaPS=sodium peroxodisulfate;

MAMol=N-methylolmethacrylamide;

Texapon NSO=sodium lauryl ether sulfate with approx. 2 mol of EO;

MAA=methacrylic acid

HPA=hydroxypropyl acrylate

HEA=hydroxyethyl acrylate

Lutavit C=ascorbic acid

DVB=divinylbenzene

AMOL=N-methylolacrylamide

### Reference Example 1

Emulsifier-Free Emulsion Polymerization without a Functional Surface

A reactor with an anchor stirrer, thermometer, gas inlet tube, charging tubes and reflux condenser was initially charged with 1300 g of water. The flask contents were then heated and stirred at a speed of 200 min⁻¹. During this time, nitrogen was supplied to the reactor. On attainment of a temperature of 85° C., the nitrogen supply was stopped and air was prevented from getting into the reactor. 10% of the monomer feed, consisting of 600 g of styrene, and 10% of a sodium peroxodisulfate solution composed of 6 g of sodium peroxodisulfate in 114 g of water, were then supplied to the reactor and preoxidized for 5 minutes, then the rest of the sodium peroxodisulfate solution was added within 3 hours. At the same time, the rest of the monomer feed was metered in for 3 hours. After the end of monomer and sodium peroxodisulfate solution feeding, the dispersion was stirred at 85° C. for a further 3 hours. The dispersion was then cooled to room temperature.

The composition of the feeds was as follows:

Initial Charge:

1300.00 g of demineralized water

Feed 1: Monomer Feed

600.00 g of styrene

Feed 2: Initiator Solution

120 g of sodium peroxodisulfate, conc. by mass 5% in water

Wet Sample Values:

AUC: Analytical ultracentrifuge

Solids content: 29.2%

Weight-average particle size AUC: 624 nm

Polydispersity index PDI (AUC): 0.09

B) Production of the Photonic Crystals

Vertical deposition onto non-vertical substrate by evaporation at room temperature.

A 3×8 cm glass microscope slide was cleaned and hydrophilized overnight with Caro's acid (H2O2:H2SO4 in a ratio of 3:7). The microscope slide was then held at 60° to the horizontal in a beaker. The emulsifier-free polymer dispersion was diluted with demineralized water to a concentration by mass of 0.3% and introduced into the beaker until the microscope slide was partly covered. In a heated cabinet at 23° C., half of the water was evaporated, then the microscope slide was removed and dried completely.

The photonic crystal thus produced was imaged with atomic force microscopy (AFM, Asylum MFP3D), and has regions of uniform crystalline fcc arrangement in the plane of the surface of the support.

When a laser beam of wavelength 488 nm (as described in Garcia-Santamaria et al., PHYSICAL REVIEW B 71 (2005) 195112) with a diameter of 1 mm is conducted onto the sample at right angles, the deflection pattern indicates crystallinity.

The thickness of the photonic crystal on the support was determined to be 40 μm. In the IR transmission, a stop band at 1400 nm with an optical density of 1.7 is found, which is likewise detected in the IR reflection.

The stability testing of the crystals which have been produced from these dispersions are summarized in the table which follows. Especially in isopropanol, after 60 seconds, large-area detachment of parts of the crystal from the glass substrate was observed. The interaction of the particles with one another in the crystal was not sufficiently great to prevent leaching-out of these large-area parts.

Irrespective of this, it was also observed by means of laser diffraction that the degree of crystallinity at 70% was not very high, i.e. proportions of 30% of the area were amorphous.

| | | | | | | Ormorcer |
|---|---|---|---|---|---|---|
| | | | | Laser | Isopropanol | isopropanol |
| Example | Composition | Water | Isopropanol | diffraction | 3 h | 1 day |
| R1 | 100 pphm of | After approx. | After approx. | 70/90 | 0% | 0% |
| | styrene, 1 pphm | 60 sec AD: | 60 sec AD: | | | |
| | of NaPS 2 kg | no detachment | detachment | | | |
| | batch at 200 rpm | | approx. 8 mm² | | | |

Explanations for the Table:

AD: Adhesion Defects: in Water or in Isopropanol:

Fragments are detached from the glass or fragments are detached from the crystal because liquid gets under a defect site, and thus “breaks up” the crystal from below. Proceeding from this point, the gap in the crystal increases.

CD: Cohesion Defects: in Water or in Isopropanol:

=Individual latices are detached from the crystal

Laser Diffraction Before the Water or Solvent Treatment

(Percentage of Crystalline Regions/Percentage of Monocrystalline fcc)

Two values are recorded by visual assessment of similar diffraction patterns when the laser beam is guided over the entire sample:
a) percentage of crystalline regions (the value becomes smaller when amorphous regions are present, identified as ring structures in the diffraction)
b) percentage of monocrystalline fcc (hexagonal diffraction pattern in the crystalline regions (the value is reduced when the angle-dependent orientation changes or if cubic (90°) patterns are present, which indicates a <100 > layer orientation).

A perfect sample has the numerical values 100/100, an amorphous sample has the numerical values 0/−.

In addition, infiltration experiments were carried out with isopropanol for three hours or Ormorcer® and isopropanol for one day: in order to write a structure (defect) into the colloid crystal, a photoresist (or material with appropriate index) has to be infiltrated. Once the defects have been written with a laser, the material subsequently has to be removed. In this removal process, the colloid crystal is detached from the substrate.

Two tests were carried out for each sample type, according to the necessary handling procedure for the removal of the infiltrated material, in this case an Ormocer®.
Test 1 placing of the sample in an isopropanol bath with gentle stirring (100 rpm) for a time of three hours
Test 2 infiltration of the photoresist over three days at room temperature. Samples were then placed into an isopropanol bath for one day, in the course of which isopropanol was occasionally replaced. The numerical values reported indicate the percentage area detached.

Ormocer®, micro resist technology GmbH, Köpenicker Str. 325, D-12555 Berlin, is an inorganic-organic hybrid polymer. As a result of this inorganic-organic network, the material properties of the ORMOCER®, for example hardness, thermal stability and chemical stability, are between those of inorganic ceramics or glasses and those of organic polymers. The refractive index can be adjusted to the particular requirements and can be varied within wide ranges. The desired ORMOCER® structures can be obtained by photostructuring.

### Reference Example 2

Emulsifier-Free Emulsion Polymerization and Swelling Polymerization

A reactor with an anchor stirrer, thermometer, gas inlet tube, charging tubes and reflux condenser was initially charged with 764.47 g of water. The flask contents were then heated and stirred at a speed of 200 min⁻¹. During this time, nitrogen was supplied to the reactor. On attainment of a temperature of 85° C., the nitrogen feed was stopped, and air was prevented from getting into the reactor. 10% of the monomer feed, consisting of 350 g of styrene, and 10% of a potassium peroxodisulfate solution composed of 1.74 g of potassium peroxodisulfate in 56.26 g of water were then supplied to the reactor and preoxidized for 5 minutes, then the remaining potassium peroxodisulfate solution was added within 3 hours. At the same time, the remainder of the monomer feed was metered in for 3 hours. After the end of monomer and potassium peroxodisulfate solution feeding, the dispersion was stirred at 85° C. for a further 3 hours. The dispersion was then cooled to room temperature.

282.69 g of this dispersion were initially charged in a reactor with an anchor stirrer, thermometer, gas inlet tube, charging tubes and reflux condenser, as were 927.01 g of water, 1.07 g of Texapon® NSO (28% in water) and 120 g of styrene. The flask contents were then stirred at room temperature at a speed of 150 min⁻¹ for 24 hours and then heated. During this time, nitrogen was supplied to the reactor. On attainment of a temperature of 75° C., the nitrogen supply was stopped and air was prevented from getting into the reactor. A sodium peroxodisulfate solution composed of 0.6 g of sodium peroxodisulfate in 7.97 g of water was then supplied to the reactor, and polymerization was completed for 7 hours. The dispersion was then cooled to room temperature.

642.86 g of this dispersion were initially charged in a reactor with an anchor stirrer, thermometer, gas inlet tube, charging tubes and reflux condenser, as were 462.70 g of water, 0.8 g of Texapon NSO (28% in water) and 90 g of styrene. The flask contents were then stirred at room temperature at a speed of 150 min⁻¹ for 24 hours, and then heated. During this time, nitrogen was supplied to the reactor. On attainment of a temperature of 75° C., the nitrogen supply was stopped and air was prevented from getting into the reactor. A sodium peroxodisulfate solution composed of 0.67 g of sodium persulfate in 8.97 g of water was then supplied to the reactor, and polymerization was completed for 7 hours. The dispersion was then cooled to room temperature.

The composition of the feeds was as follows:

1st Stage:

Initial Charge:

764.47 g of demineralized water

Feed 1: Monomer Feed

350.00 g of styrene

Feed 2: Initiator Solution

58 g of potassium peroxodisulfate, conc. by mass: 3% in water

2nd Stage:

Initial Charge:

927.01 g of demineralized water

282.69 g of seed (polystyrene particles from 1st stage), conc. by mass: 28.3% in water

1.07 g of Texapon NSO, conc. by mass: 28% in water

120.00 g of styrene

Feed 1: Initiator Solution

8.57 g of sodium peroxodisulfate, conc. by mass: 7% in water

3rd Stage:

Initial Charge:

462.70 g of demineralized water

642.86 g of seed (polystyrene particles from 2nd stage), conc. by mass: 14% in water

0.80 g of Texapon NSO, conc. by mass: 28% in water

90.00 g of styrene

Feed 1: Initiator Solution

9.64 g of sodium peroxodisulfate, conc. by mass: 7% in water

Wet Sample Values:

Solids content: 14.6%

AUC: 963 nm

PDI (AUC): 0.06

The resulting polymer particles had a weight-average particle size of 963 nm and a polydispersity index of 0.06.

The stability test of the crystals which were produced from these dispersions gave comparably negative values to those in reference example 1. Especially in isopropanol, after 60 seconds, large-area detachment of parts of the crystal from the glass substrate was observed. The interaction of the particles with one another in the crystal was not sufficiently great to prevent leaching-out of these large-area parts.

By means of laser diffraction, it was observed that the degree of crystallinity, about 60%, was even lower than in the preceding reference example 1, i.e. proportions of 40% of the area were amorphous.

### Example 3

### Swelling+Reactive Monomer on the Surface

A reactor with an anchor stirrer, thermometer, gas inlet tube, charging tubes and reflux condenser was initially charged with 1928.33 g of water. The flask contents were subsequently heated and stirred at a speed of 200 min⁻¹. During this time, nitrogen was supplied to the reactor. On attainment of a temperature of 85° C., the nitrogen supply was stopped, and air was prevented from getting into the reactor. 10% of the monomer feed, consisting of 890 g of styrene, and 10% of a sodium peroxodisulfate solution composed of 8.9 g of sodium peroxodisulfate in 169.1 g of water, were then supplied to the reactor and preoxidized for 5 minutes, then the remaining sodium peroxodisulfate solution was added within 3 hours. At the same time, the remainder of the monomer feed was metered in for 3 hours. After the end of monomer and sodium peroxodisulfate solution feeding, the dispersion was stirred at 85° C. for a further 3 hours. The dispersion was then cooled to room temperature.

671.30 g of this dispersion were then initially charged in a reactor with an anchor stirrer, thermometer, gas inlet tube, charging tubes and reflux condenser, as were 2127.84 g of water, 2.59 g of Texapon NSO (28% in water) and 290 g of styrene. The flask contents were then stirred at room temperature at a speed of 150 min⁻¹ for 24 hours and then heated. During this time, nitrogen was supplied to the reactor. On attainment of a temperature of 75° C., the nitrogen feed was stopped and air was prevented from getting into the reactor. A sodium peroxodisulfate solution composed of 1.45 g of sodium persulfate in 143.55 g of water was then supplied to the reactor over 5 hours and polymerized to completion at 75° C. for 2 hours. The dispersion was then cooled to room temperature.

600 g of this dispersion were initially charged in a reactor with an anchor stirrer, thermometer, gas inlet tube, charging tubes and reflux condenser, as were 458.50 g of water, 0.8 g of Texapon® NSO (28% in water), 86.40 g of styrene, 12.00 g of N-methylolmethacrylamide (15% in water) and 1.8 g of divinylbenzene. The flask contents were then stirred at room temperature at a speed of 150 min⁻¹ for 24 hours, and then heated. During this time, nitrogen was supplied to the reactor. On attainment of a temperature of 75° C., the nitrogen supply was stopped, and air was prevented from getting into the reactor. A sodium peroxodisulfate solution composed of 0.45 g of sodium peroxodisulfate in 44.55 g of water was then supplied to the reactor over 5 hours, and polymerization was completed at 75° C. for 2 hours. The dispersion was then cooled to room temperature.

The Composition of the feeds was as follows:

Initial Charge:

1928.33 g of demineralized water

Feed 1: Monomer Feed

890.00 g of styrene

Feed 2: Initiator Solution

178.00 g of sodium peroxodisulfate, conc. by mass: 5% in water

2nd Stage:

Initial Dharge:

2127.84 g of demineralized water

671.30 g of seed (polystyrene particles from 1st stage), conc. by mass: 28.8% in water

2.59 g of Texapon NSO, conc. by mass: 28% in water

290.00 g of styrene

Feed 1: Initiator Solution

145.00 g of sodium peroxodisulfate, conc. by mass: 1% in water

3rd Stage:

Initial Charge:

458.50 g of demineralized water

600.00 g of seed (polystyrene particles from 2nd stage), conc. by mass: 14.3% in water

0.80 g of Texapon NSO, conc. by mass: 28% in water

86.40 g of styrene

12.00 g of N-methylolmethacrylamide, conc. by mass: 15% in water

1.80 g of divinylbenzene

Feed 1: Initiator Solution

45.00 g of sodium peroxodisulfate, conc. by mass: 1% in water

Wet Sample Values:

Solids content: 13.8%

AUC: 905 nm

PDI (AUC): 0.17

### Particles with Reactive Surfaces

| | | | Analogous to | | | | | |
|---|---|---|---|---|---|---|---|---|
| | | | example 3 | | | | | LZH |
| | Sample from | | except | | | | LZH | Ormorcer |
| | ex./heat | | composition | | | Laser | isopropanol | isopropanol |
| Example | treatment | Morphology | for 3rd stage | Water | Isopropanol | diffraction | 3 h | 1 day |
| 9 | untreated | reactive | 98 pphm | after 60 sec | after 60 sec | 95/90 | 0% | 0% |
| | | surface | styrene, | AD: approx. | CD: no | | | |
| | | | 2 pphm MAMol, | 5 mm² | streaks | | | |
| | | | 0.25 pphm | starting | | | | |
| | | | Texapon NSO, | from defect | | | | |
| | | | 0.5 pphm | | | | | |
| | | | NaPS, seed | | | | | |
| 10 | 9 | reactive | | after 30 sec | after 60 sec | 95/90 | 90% | 80% |
| | 1 h at 100° C. | surface | | AD: start of | AD: no | | | |
| | | activated | | detachment | detachment | | | |
| | | | | at the | CD: streak | | | |
| | | | | meniscus | formation 0 | | | |
| | | | | after 60 sec | to 40 sec | | | |
| | | | | approx. 8 mm² | | | | |
| 11 | 3 | reactive | 98 pphm | after 30 sec | after 5 sec | 90/90 | 0% | 0% |
| | untreated | surface | styrene, | AD: approx. | CD: slight | | AD: | |
| | | | 2 pphm AMol, | 1-5 mm² | streaks - no | | 1 mm² | |
| | | | 0.25 pphm | | cloudiness | | | |
| | | | Texapon NSO, | | after 1 min, | | | |
| | | | 0.5 pphm | | no further | | | |
| | | | NaPS, seed | | streaks | | | |
| 12 | 11 | reactive | | after 60 sec | after 5 sec | 90/90 | 95% | 60% |
| | 1 h at 100° C. | surface | | no change | to approx. | | | |
| | | activated | | | 30 sec CD: | | | |
| | | | | | slight | | | |
| | | | | | streaks, | | | |
| | | | | | then no | | | |
| | | | | | further | | | |
| | | | | | streaks | | | |
| 13 | 3 | reactive | 96 pphm | after 60 sec | after 60 sec | 95/90 | 0% | 0% |
| | untreated | surface | styrene, | AD: no | AD: no | | | |
| | | | 2 pphm MAMol, | detachment | detachment | | | |
| | | | 2 pphm DVB, | | | | | |
| | | | 0.25 pphm | | | | | |
| | | | Texapon NSO, | | | | | |
| | | | 0.5 pphm | | | | | |
| | | | NaPS, seed | | | | | |
| 14 | 13 | reactive | | after 60 sec | after 60 sec | 80/90 | 95% | 90% |
| | 1 h at 100° C. | surface | | AD: no | AD: no | | | |
| | | activated | | detachment | detachment | | | |
| | | | | | CD: no | | | |
| | | | | | streak | | | |
| | | | | | formation | | | |
| 3 | untreated | reactive | 96 pphm | after 60 sec | after 60 sec | 95/90 | 95% | 60% |
| | | surface | styrene, | AD: no | AD: no | | | 1 d ISO at |
| | | | 2 pphm MAMol, | detachment | detachment | | | GKP 50% |
| | | | 2 pphm DVB | | CD: no | | | |
| | | | 0.25 pphm | | streak | | | |
| | | | Texapon NSO, | | formation | | | |
| | | | 1 pphm NaPS, | | | | | |
| | | | 0.25 pphm | | | | | |
| | | | Lutavit C, | | | | | |
| | | | seed | | | | | |
| | | | polym. t.: | | | | | |
| | | | 60° C. | | | | | |
| 4 | 3. | reactive | | after 60 sec | after 60 sec | 90/90 | 100% | 100% |
| | 1 h at 100° C. | surface | | AD: no | AD: no | | | 1 d ISO at |
| | | activated | | detachment | detachment | | | GKP 100% |
| | | | | | CD: no | | | |
| | | | | | streak | | | |
| | | | | | formation | | | |
| 5 | 3 | reactive | | after 60 sec | after 60 sec | 90/90 | 100% | 1 d ISO at |
| | 24 h at 90° C. | surface | | AD: no | AD: no | | | GKP 100% |
| | | activated | | detachment | detachment | | | |
| | | | | | CD: no | | | |
| | | | | | streak | | | |
| | | | | | formation | | | |
| 6 | 3 | reactive | Laser | after 60 sec | after 60 sec | 90/90 | 100% | 100% |
| | 6 h at 95° C. | surface | diffraction: | AD: no | AD: no | | | |
| | | activated | for immersion | detachment | detachment | | | |
| | | | test | | CD: no | | | |
| | | | reproduction | | streak | | | |
| | | | samples with | | formation | | | |
| | | | smaller | | | | | |
| | | | crystal area | | | | | |
| | | | in some cases | | | | | |
| | | | ((A < 90)/90) | | | | | |
| 7 | 3 | reactive | | after 60 sec | after 60 sec | 90/90 | 100% | 100% |
| | 3 h at 100° C. | surface | | AD: no | AD: no | | | |
| | | activated | | detachment | detachment | | | |
| | | | | | CD: no | | | |
| | | | | | streak | | | |
| | | | | | formation | | | |
| 8 | 3 | reactive | | after 60 sec | after 60 sec | 90/90 | 100% | 100% |
| | 2 h at 100° C. | surface | | AD: no | AD: no | | | |
| | | activated | | detachment | detachment | | | |
| | | | | | CD: no | | | |
| | | | | | streak | | | |
| | | | | | formation | | | |
| 15 | 3 | | 98 pphm | after approx. | after approx. | 70/90 | 0% | 0% |
| | untreated | | styrene, | 60 sec CD: | 60 sec AD: | | | |
| | | | 2 pphm DAAM, | sample | detachment | | | |
| | | | 0.25 pphm | dissolves, | approx. | | | |
| | | | Texapon NSO, | water becomes | 8 mm² | | | |
| | | | 0.5 pphm | cloudy | | | | |
| | | | NaPS, seed, | | | | | |
| | | | polym. temp. | | | | | |
| | | | 75° C. | | | | | |
| 16 | 15 + ADDH | | | after 60 sec | after 60 sec | 70/90 | 100% | 100% |
| | ratio of | | | AD: no | AD: no | | | |
| | DAAM:ADDH = 2:1 | | | detachment | detachment | | | |
| | | | | | CD: no | | | |
| | | | | | streak | | | |
| | | | | | formation | | | |
| 17 | 15 + ADDH | | | after 60 sec | after 60 sec | 70/90 | 100% | 90% |
| | ratio of | | | AD: no | AD: no | | | |
| | DAAM:ADDH = 4:1 | | | detachment | detachment | | | |
| | | | | | CD: no | | | |
| | | | | | streak | | | |
| | | | | | formation | | | |
| 18 | 15 + ADDH | | | after 60 sec | after 60 sec | 70/90 | 90% | 80% |
| | ratio of | | | AD: no | AD: no | | | |
| | DAAM:ADDH = 6:1 | | | detachment | detachment | | | |
| | | | | | CD: no | | | |
| | | | | | streak | | | |
| | | | | | formation | | | |
| 19 | 15 + ADDH | | | after 60 sec | after 60 sec | 70/90 | 80% | 60% |
| | ratio of | | | AD: no | AD: no | | | |
| | DAAM:ADDH = 8:1 | | | detachment | detachment | | | |
| | | | | | CD: no | | | |
| | | | | | streak | | | |
| | | | | | formation | | | |
| 20 | 3 + 0.5 part of | | 95 pphm | after 60 sec | after 60 sec | 80/70 | 100% | 70% |
| | melamine- | | styrene, | AD: no | AD: no | | | |
| | formaldehyde | | 5 pphm HEA, | detachment | detachment | | | |
| | oligomer | | 0.25 pphm | | CD: no | | | |
| | | | Texapon NSO, | | streak | | | |
| | | | 0.5 pphm | | formation | | | |
| | | | NaPS, seed | | | | | |
| 21 | 3 + 2 parts of | | 95 pphm | after 60 sec | after 60 sec | 80/70 | 90% | 80% |
| | (solid on | | styrene, | AD: no | AD: no | | | |
| | solid) | | 5 pphm HPA, | detachment | detachment | | | |
| | melamine- | | 0.25 pphm | | CD: no | | | |
| | formaldehyde | | Texapon NSO, | | streak | | | |
| | oligomer | | 0.5 pphm | | formation | | | |
| | Luwipal ® | | NaPS, seed | | | | | |
| 22 | 3 + 4 parts of | | 96 pphm | after 60 sec | after 60 sec | 80/70 | 100% | 90% |
| | (solid on | | styrene, | AD: no | AD: no | | | |
| | solid) | | 4 pphm AA, | detachment | detachment | | | |
| | melamine- | | 0.25 pphm | | CD: no | | | |
| | formaldehyde | | Texapon NSO, | | streak | | | |
| | oligomer | | 0.5 pphm | | formation | | | |
| | Luwipal ® | | NaPS, seed | | | | | |
| 23 | 3 + 6 parts of | | 96 pphm | after 60 sec | after 60 sec | 80/70 | 100% | 90% |
| | (solid on | | styrene, | AD: no | AD: no | | | |
| | solid) | | 4 pphm MAA, | detachment | detachment | | | |
| | melamine- | | 0.25 pphm | | CD: no | | | |
| | formaldehyde | | Texapon NSO, | | streak | | | |
| | oligomer | | 0.5 pphm | | formation | | | |
| | Luwipal ® | | NaPS, seed | | | | | |
| 24 | 3 + disodium | | 95 pphm | after 60 sec | after 60 sec | 90/80 | 100% | 90% |
| | tetraborate | | styrene, | AD: no | AD: no | | | |
| | (the molar | | 5 pphm HEA, | detachment | detachment | | | |
| | ratio of | | 0.25 pphm | | CD: no | | | |
| | HEA:disodium | | Texapon NSO, | | streak | | | |
| | tetraborate = | | 0.5 pphm | | formation | | | |
| | 2:1) | | NaPS, seed | | | | | |
| 25 | 3 + disodium | | 95 pphm | after 60 sec | after 60 sec | 90/80 | 90% | 70% |
| | tetraborate | | styrene, | AD: no | AD: no | | | |
| | (the molar | | 5 pphm HPA, | detachment | detachment | | | |
| | ratio of | | 0.25 pphm | | CD: no | | | |
| | HPA:disodium | | Texapon NSO, | | streak | | | |
| | tetraborate = | | 0.5 pphm | | formation | | | |
| | 2:1) | | NaPS, seed | | | | | |
| 26 | 3 + disodium | | 96 pphm | after 60 sec | after 60 sec | 60/90 | 100% | 80% |
| | tetraborate | | styrene, | AD: no | AD: no | | | |
| | (the molar | | 4 pphm AA, | detachment | detachment | | | |
| | ratio of | | 0.25 pphm | | CD: no | | | |
| | AA:disodium | | Texapon NSO, | | streak | | | |
| | tetraborate = | | 0.5 pphm | | formation | | | |
| | 2:1) | | NaPS, seed | | | | | |
| | | | polym. t.: | | | | | |
| | | | 75° C. | | | | | |
| 27 | 3 + disodium | | 96 pphm | after 60 sec | after 60 sec | 60/90 | 100% | 90% |
| | tetraborate | | styrene, | AD: no | AD: no | | | |
| | (the molar | | 4 pphm MAA, | detachment | detachment | | | |
| | ratio of | | 0.25 pphm | | CD: no | | | |
| | MAA:disodium | | Texapon NSO, | | streak | | | |
| | tetraborate = | | 0.5 pphm | | formation | | | |
| | 2:1) | | NaPS, seed | | | | | |
| | | | polym. t.: | | | | | |
| | | | 75° C. | | | | | |

The production of the examples cited in the tables is always the same up to the 2nd stage, only the composition of the 3rd stage was changed.

Crosslinkers: Crystals of the dispersions from example 13 and 14 and examples 3 to 8 with crosslinker (in each case 2pphm of MAMOL and DVB) show significantly better stability compared to water and isopropanol.

It has been found that heat treatment at 95° C. for six hours or at 90° C. for 24 hours is sufficient to achieve bridging and good isopropanol resistance combined with greatly reduced cracking effects. Heat treatment at 95° C. for one hour already led to significantly improved resistance compared to the unreactive samples.

### Examples 28-33

### Particles with Acid on the Surface

| | | | Analogous to | | | | | |
|---|---|---|---|---|---|---|---|---|
| | | | example 3 | | | | | |
| | Sample from | | apart from | | | | | Ormorcer |
| | Ex./heat | | composition | | | Laser | Isopropanol | isopropanol |
| Example | treatment | Morphology | for 3rd stage | Water | Isopropanol | diffraction | 3 h | 1 day |
| 28 | untreated | | 98 pphm | immediate: | after 1 min | 60/90 | 90% | 50% |
| | | | styrene, | CD/AD: crystal | no detachment | | AD: | |
| | | | 2 pphm MAA, | dissolves | or streaks | | 1 mm² | |
| | | | 0.75 pphm | completely | AD: at the | | | |
| | | | NaPS, seed | in the water, | meniscus, | | | |
| | | | | water becomes | detachment | | | |
| | | | | cloudy | is observed, | | | |
| | | | | | free glass is | | | |
| | | | | | becoming | | | |
| | | | | | visible | | | |
| 29 | 28 | tempered | | after approx. | after 5 to | 70/90 | 100% | 80% |
| | 24 h at | | | 25 sec CD: | 30 sec | | | |
| | 90° C. | | | sample | CD: streak | | | |
| | | | | dissolves, | formation | | | |
| | | | | water becomes | after 1 min | | | |
| | | | | cloudy | AD: at the | | | |
| | | | | | meniscus, | | | |
| | | | | | detachment | | | |
| | | | | | is observed, | | | |
| | | | | | 1 mm² | | | |
| 30 | 0.001% | silane | | after approx | after 20 to | 50/90 | 100% | 90% |
| | amino- | coupling | | 60 sec AD: | 30 sec | | | |
| | methyl- | agent + | | approx. 1 mm² | CD: streak | | | |
| | silane, | tempered**) | | | formation | | | |
| | 24 h at 90° C. | | | | AD: even | | | |
| | | | | | after 60 sec, | | | |
| | | | | | no detachment | | | |
| 31 | | | 96 pphm | immediate: | after 1 min | 60/90 | 90% | 50% |
| | | | styrene, | CD/AD: crystal | no detachment | | AD: | |
| | | | 4 pphm MAA, | dissolves | or streaks | | 1 mm² | |
| | | | 0.25 pphm | completely | AD: at the | | | |
| | | | Texapon NSO, | in the water, | meniscus, | | | |
| | | | 0.5 pphm | water becomes | detachment | | | |
| | | | NaPS seed | cloudy | is observed, | | | |
| | | | polym. t.: | | free glass is | | | |
| | | | 75° C. | | becoming | | | |
| | | | | | visible | | | |
| 32 | | | 50 pphm | | after 60 sec | 30/90 | 50% | 20% |
| | | | styrene, | | AD: no | | | |
| | | | 50 pphm t-BA, | | detachment | | | |
| | | | 0.25 pphm | | CD: no streak | | | |
| | | | Texapon NSO, | | formation | | | |
| | | | 1 pphm NaPS, | | | | | |
| | | | 0.25 pphm | | | | | |
| | | | Lutavit C, | | | | | |
| | | | seed polym. | | | | | |
| | | | temperature: | | | | | |
| | | | 60° C. | | | | | |
| 33 | | | 50 pphm | | after 60 sec | 70/80 | 90% | 80% |
| | | | styrene, | | AD: no | | | |
| | | | 50 pphm t-BA, | | detachment | | | |
| | | | 0.25 pphm | | CD: no streak | | | |
| | | | Texapon NSO, | | formation | | | |
| | | | 1 pphm NaPS, | | | | | |
| | | | 0.25 pphm | | | | | |
| | | | Lutavit C, | | | | | |
| | | | seed polym. | | | | | |
| | | | temperature: | | | | | |
| | | | 60° C., then | | | | | |
| | | | stirred at | | | | | |
| | | | 95° C. for 5 h | | | | | |
| | | | in order | | | | | |
| | | | to prepare | | | | | |
| | | | acrylic acid | | | | | |
| | | | from t-BA | | | | | |

t-BA = tert-butyl acrylate
**)glass-coated with aminomethylsilane (no long alkyl chain) in the gas phase = monolayer

Regarding example 28/29

In contrast to the other dispersions, this has a very good water-soluble content in the shell at 2 pphm of MAA. As a result, the crystal dissolves very efficiently in the water. The heat treatment can slow this dissolution, presumably by interparticulate anhydride formation.

Below 90° C., the anhydride formation of the interparticulate crosslinking is present but not yet optimal; above 90° C., the particle of polystyrene begins to soften, and the cavity between the spheres which is required for the inversion of the photonic crystal is lost.

Therefore, the result of the stabilization of the crystal is optimal at 90° C.

The diffraction images of the single crystal were recorded with a laser beam widened out up to 1.8 cm. The identical scattering patterns with increasing beam widening demonstrate that the 2 cm×2 cm area is a single crystal.

### Examples 34-37

### Particles with Salt Crosslinking with Zinc

| | | | Analogous to | | | | | |
|---|---|---|---|---|---|---|---|---|
| | | | example 3 | | | | | |
| | | | apart from | | | | | Ormorcer |
| | Sample from | | composition | | | Laser | Isopropanol | isopropanol |
| Example | ex./salt | Morphology | for 3rd stage | Water | Isopropanol | diffraction | 3 h | 1 day |
| 34 | 3 + ZnCl₂ | | 96 pphm | immediate: | after 1 min | 60/90 | 30% | 10% |
| | | | styrene, | CD/AD: | no detachment | | AD: | |
| | | | 4 pphm AA, | crystal | or streaking | | 1 mm² | |
| | | | 0.25 pphm | dissolves | AD: at the | | | |
| | | | Texapon NSO, | completely | meniscus, | | | |
| | | | 0.5 pphm | in the water | detachment | | | |
| | | | NaPS, seed | water becomes | is observed, | | | |
| | | | polym. t.: | cloudy | free glass | | | |
| | | | 75° C. | | becomes | | | |
| | | | | | visible | | | |
| 35 | 3 + Zn(NH₃)₄(HCO₃)₂ | | | after approx. | after 5 to | 70/90 | 100% | 80% |
| | solution + 2% | | | 25 sec CD: | 30 sec | | | |
| | Texapon NSO | | | sample | CD: streak | | | |
| | (AA/Zn complex, | | | dissolves, | formation | | | |
| | without heat | | | water becomes | after 1 min | | | |
| | treatment) | | | cloudy | | | | |
| 36 | 31 + Zn(NH₃)₄(HCO₃)₂ | | 96 pphm | after approx. | after 5 to | 60/90 | 100% | 90% |
| | solution + 2% | | styrene, | 20 sec CD: | 30 sec | | | |
| | Texapon NSO | | 4 pphm MAA, | sample | CD: streak | | | |
| | (AA/Zn complex, | | 0.25 pphm | dissolves, | formation | | | |
| | without heat | | Texapon NSO, | water becomes | after 1 min | | | |
| | treatment) | | 0.5 pphm | cloudy | | | | |
| | | | NaPS, seed | | | | | |
| | | | polym. t.: | | | | | |
| | | | 75° C. | | | | | |
| 37 | 3 + Zn(NH₃)₄(HCO₃)₂— | | 50 pphm | after approx. | after 5 to | 70/90 | 100% | 90% |
| | solution + 2% | | styrene, | 25 sec CD: | 30 sec | | | |
| | Texapon NSO | | 50 pphm t-BA, | sample | CD: streak | | | |
| | (AA/Zn complex | | 0.25 pphm | dissolves, | formation | | | |
| | without heat | | Texapon NSO, | water becomes | after 1 min | | | |
| | treatment) | | 1 pphm NaPS, | cloudy | | | | |
| | | | 0.25 pphm | | | | | |
| | | | Lutavit C, | | | | | |
| | | | seed polym. | | | | | |
| | | | temperature: | | | | | |
| | | | 60° C., then | | | | | |
| | | | stirred at | | | | | |
| | | | 95° C. for 5 h | | | | | |
| | | | in order to | | | | | |
| | | | prepare | | | | | |
| | | | acrylic acid | | | | | |
| | | | from t-BA | | | | | |

AA = acrylic acid

For crosslinking, a zinc solution consisting of 16% NH₃, 12% NH₄HCO₃ and 7% ZnO is employed.

The feedstocks form a Zn(NH₃)₄(HCO₃)₂ complex therefrom. The carbonate is a weaker ion than the carboxyl group of the acid; the Zn²⁺ is therefore deposited thereon. As the film dries, the ammonia and the CO₂ are volatilized.

The dispersions were stabilized with 2% Texapon® NSO, then adjusted to pH=8 with ammonia, and then the complex was added.

### Example 38

### Swelling+Polar Monomer on the Surface

A reactor with an anchor stirrer, thermometer, gas inlet tube, charging tubes and reflux condenser was initially charged with 1928.33 g of water. The flask contents were subsequently heated and stirred at a speed of 200 min−1. During this time, nitrogen was supplied to the reactor. On attainment of a temperature of 85° C., the nitrogen supply was stopped, and air was prevented from getting into the reactor. 10% of the monomer feed, consisting of 890 g of styrene, and 10% of a sodium peroxodisulfate solution composed of 8.9 g of sodium peroxodisulfate in 169.1 g of water, were then supplied to the reactor and preoxidized for 5 minutes, then the remaining sodium peroxodisulfate solution was added within 3 hours. At the same time, the remainder of the monomer feed was metered in for 3 hours. After the end of monomer and sodium peroxodisulfate solution feeding, the dispersion was stirred at 85° C. for a further 3 hours. The dispersion was then cooled to room temperature.

671.30 g of this dispersion were initially charged in a reactor with an anchor stirrer, thermometer, gas inlet tube, charging tubes and reflux condenser, as were 2127.84 g of water, 2.59 g of Texapon® NSO (28% in water) and 290 g of styrene. The flask contents were then stirred at room temperature at a speed of 150 min−1 for 24 hours and then heated. During this time, nitrogen was supplied to the reactor. On attainment of a temperature of 75° C., the nitrogen supply was stopped and air was prevented from getting into the reactor. A sodium peroxodisulfate solution composed of 1.45 g of sodium peroxodisulfate in 143.55 g of water was then supplied to the reactor over 5 hours and polymerized to completion at 75° C. for 2 hours. The dispersion was then cooled to room temperature.

600 g of this dispersion were initially charged in a reactor with an anchor stirrer, thermometer, gas inlet tube, charging tubes and reflux condenser, as were 468.70 g of water, 0.8 g of Texapon NSO (28% in water), 85.50 g of styrene and 4.5 g of butanediol monoacrylate. The flask contents were then stirred at room temperature at a speed of 150 min−1 for 24 hours and then heated. During this time, nitrogen was supplied to the reactor. On attainment of a temperature of 75° C., the nitrogen supply was stopped and air was prevented from getting into the reactor. A sodium peroxodisulfate solution composed of 0.45 g of sodium peroxodisulfate in 44.55 g of water was then supplied to the reactor over 5 hours and polymerized to completion at 75° C. for 2 hours. The dispersion was then cooled to room temperature.

The Composition of the Feeds was as Follows:

Initial Charge:

1928.33 g of demineralized water

Feed 1: Monomer Feed

890.00 g of styrene

Feed 2: Initiator Solution

178.00 g of sodium, peroxodisulfate, conc. by mass: 5% in water

2nd Stage:

Initial Charge:

2127.84 g of demineralized water

671.30 g of seed (polystyrene particles from 1st stage), conc. by mass: 28.8% in water

2.59 g of Texapon NSO, conc. by mass: 28% in water

290.00 g of styrene

Feed 1: Initiator Solution

145.00 g of sodium peroxodisulfate, conc. by mass: 1% in water

3rd Stage:

Initial Charge:

468.70 g of demineralized water

600.00 g of seed (polystyrene particles from 2nd stage), conc. by mass: 14.3% in water

0.80 g of Texapon NSO, conc. by mass: 28% in water

85.50 g of styrene

4.50 g of butanediol monoacrylate

Feed 1: Initiator Solution

45.00 g of sodium peroxodisulfate, conc. by mass: 1% in water

Wet Sample Values:

Solids content:: 13.9%

AUC: 880 nm

PDI (AUC): 0.27

Particles with a Polar Surface

| | | | Analogous to | | | | | |
|---|---|---|---|---|---|---|---|---|
| | | | example 38 | | | | | |
| | Sample from | | apart from | | | | | Ormorcer |
| | ex./heat | | composition | | | Laser | Isopropanol | isopropanol |
| Example | treatment | Morphology | for 3rd stage | Water | Isopropanol | diffraction | 3 h | 1 day |
| 39 | untreated | sticky | 95 pphm | after 60 sec | after 60 sec | 95/85 | 50% | 80% |
| | | shell | styrene, | AD: no | AD: no | | AD: | |
| | | | 5 pphm HEA, | detachment | detachment | | 1 mm² | |
| | | | 0.25 pphm Texapon NSO, | | CD: no | | | |
| | | | 0.5 pphm NaPS, | | streak | | | |
| | | | seed | | formation | | | |
| 40 | 39 | | | after 60 sec | after 60 sec | 85/85 | | |
| | 1 h at 100° C. | | | AD: no | AD: no | | | |
| | | | | detachment | detachment | | | |
| | | | | | CD: no | | | |
| | | | | | streak | | | |
| | | | | | formation | | | |
| 38 | untreated | cross- | 95 pphm | | after 60 sec | 60/90 | 100% | 100% |
| | | linker | styrene, | | AD: no | | | |
| | | | 5 pphm BDA, | | detachment | | | |
| | | | 0.25 pphm | | CD: no | | | |
| | | | Texapon NSO, | | streak | | | |
| | | | 0.5 pphm NaPS, | | formation | | | |
| | | | seed | | | | | |
| | | | BDA(butanediol | | | | | |
| | | | monoacrylate) | | | | | |
| 41 | untreated | sticky | 95 pphm | | | 90/90 | 50% | 40% |
| | | shell | styrene, | | | | AD: | |
| | | | 5 pphm HPA, | | | | 1 mm² | |
| | | | 0.25 pphm Texapon NSO, | | | | | |
| | | | 0.5 pphm NaPS, | | | | | |
| | | | seed | | | | | |

The polar surface of the particles leads to a physical (or else chemical) interaction of the particles which, even without heat treatment, increases the stability of the crystal to an extreme degree and attains the values of the reactive heat-treated samples.

### Example 42

### Soft Surface

A reactor with an anchor stirrer, thermometer, gas inlet tube, charging tubes and reflux condenser was initially charged with 1928.33 g of water. The flask contents were subsequently heated and stirred at a speed of 200 min−1. During this time, nitrogen was supplied to the reactor. On attainment of a temperature of 85° C., the nitrogen supply was stopped, and air was prevented from getting into the reactor. 10% of the monomer feed, consisting of 890 g of styrene, and 10% of a sodium peroxodisulfate solution composed of 8.9 g of sodium peroxodisulfate in 169.1 g of water, were then supplied to the reactor and preoxidized for 5 minutes, then the remaining sodium peroxodisulfate solution was added within 3 hours. At the same time, the remainder of the monomer feed was metered in for 3 hours. After the end of monomer and sodium peroxodisulfate solution feeding, the dispersion was stirred at 85° C. for a further 3 hours. The dispersion was then cooled to room temperature.

671.30 g of this dispersion were initially charged in a reactor with an anchor stirrer, thermometer, gas inlet tube, charging tubes and reflux condenser, as were 2127.84 g of water, 2.59 g of Texapon® NSO (28% in water) and 290 g of styrene. The flask contents were then stirred at room temperature at a speed of 150 min−1 for 24 hours and then heated. During this time, nitrogen was supplied to the reactor. On attainment of a temperature of 75° C., the nitrogen supply was stopped and air was prevented from getting into the reactor. A sodium peroxodisulfate solution composed of 1.45 g of sodium peroxodisulfate in 143.55 g of water was then supplied to the reactor over 5 hours and polymerized to completion at 75° C. for 2 hours. The dispersion was then cooled to room temperature.

600 g of this dispersion were initially charged in a reactor with an anchor stirrer, thermometer, gas inlet tube, charging tubes and reflux condenser, as were 355.86 g of water, 0.8 g of Texapon® NSO (28% in water), 45.00 g of styrene, 45.00 g of n-butyl acrylate and 0.05 g of Dissolvine E-Fe 6. The flask contents were then stirred at room temperature at a speed of 150 min−1 for 24 hours and then heated. During this time, nitrogen was supplied to the reactor. On attainment of a temperature of 60° C., the nitrogen supply was stopped and air was prevented from getting into the reactor. A sodium peroxodisulfate solution composed of 0.9 g of sodium peroxodisulfate in 89.10 g of water and 0.18 g of Lutavit® C in 71.82 g of water was then supplied to the reactor over 5 hours and polymerized to completion at 60° C. for 2 hours. The dispersion was then cooled to room temperature.

The composition of the feeds was as follows:

Initial Charge:

1928.33 g of demineralized water

Feed 1: Monomer Feed

890.00 g of styrene

Feed 2: Initiator Solution

178.00 g of sodium peroxodisulfate, conc. by mass: 5% in water

2nd Stage:

Initial Charge:

2127.84 g of demineralized water

671.30 g of seed (polystyrene particles from 1st stage), conc. by mass: 28.8% in water

2.59 g of Texapon NSO, conc. by mass: 28% in water

290.00 g of styrene

Feed 1: Initiator Solution

145.00 g of sodium peroxodisulfate, conc. by mass: 1% in water

3rd Stage:

Initial Charge:

355.86 g of demineralized water

600.00 g of seed (polystyrene particles from 2nd stage), conc. by mass: 14.3% in water

0.80 g of Texapon NSO, conc. by mass: 28% in water

45.00 g of styrene

45.00 g of n-butyl acrylate

Feed 1: Initiator Solution

90.00 g of sodium peroxodisulfate, conc. by mass: 1% in water

Redox Feed:

72.00 g of Lutavit C, conc. by mass: 0.25% in water

Wet Sample Values:

solids content: 14.5%

AUC: 1105 nm

PDI (AUC): 0.101

| | | | Analogous to | | | | | |
|---|---|---|---|---|---|---|---|---|
| | | | example 38 | | | | | |
| | | | apart from | | | | | Ormorcer |
| | Sample | | composition | | | Laser | Isopropanol | isopropanol |
| Example | from ex. | Morphology | for 3rd stage | Water | Isopropanol | diffraction | 3 h | 1 day |
| 42 | | sticky | 50 pphm | after approx. | after 60 sec | 90/90 ** | 100% | 1 d ISO at |
| | | shell | styrene, | 60 sec | AD: no | | | GKP 100% |
| | | | 50 pphm n-BA, | AD: no | detachment | | | |
| | | | 0.25 pphm | detachment | CD: no | | | |
| | | | Texapon NSO, | | streak | | | |
| | | | 1 pphm NaPS, | | formation | | | |
| | | | 0.25 pphm | | | | | |
| | | | Lutavit C, | | | | | |
| | | | seed | | | | | |
| | | | polym. t.: | | | | | |
| | | | 60° C. | | | | | |

A challenge in the production of photonic crystals with very large surface areas consists in the fact that cracks form very readily in the surface in the course of drying of the dispersion to give the crystalline films and, though they do not disrupt the alignment of the crystalline order, nevertheless convert the single crystals to a multicrystalline arrangement, which limits the possible uses. These cracks are referred to as particle interfaces in crystallography. It has now been found that, surprisingly, soft constituents on the surface significantly reduce the number of these particle interfaces and even enable single crystals in the centimeter range to be grown without particle interfaces. These soft constituents on the surface can also be combined with polar or reactive constituents on the surface of the particles.

Dispersions for Photonic Crystals which can be Crosslinked in an Interparticulate Manner or Structured Three-Dimensionally by UV Irradiation

### Examples 43 to 46

### Trimethylolpropane tri(ethoxyacrylate) (Laromer® 8863 from Ciba Speciality Chemicals) Dissolved in Aqueous form in the Serum of the Dispersion and UV Crosslinking by Irradiation of the Pphotonic Crystal with UV Light (Free-Radical)

The UV initiator is a free-radical initiator which starts to swell the particle surface, penetrates into it and is thus crosslinked.

Imagewise illumination for structuring the photonic crystal and for producing an inverse photonic crystal is thus also possible.

UV Crosslinking, Free-Radical

| | | | Analogous to | | | | | |
|---|---|---|---|---|---|---|---|---|
| | | | example 3 | | | | | |
| | | | apart from | | | | | Ormorcer |
| | Sample from | | composition | | | Laser | Isopropanol | isopropanol |
| Example | ex./blend | Morphology | for 3rd stage | Water | Isopropanol | diffraction | 3 h | 1 day |
| 43 | | | 100 pphm | after approx. | after approx. | 70/90 | 0% | 0% |
| | | | styrene, | 60 sec | 60 sec AD: | | | |
| | | | 0.25 pphm | AD: no | detachment | | | |
| | | | Texapon NSO, | detachment | approx. | | | |
| | | | 0.75 pphm | | 10 mm² | | | |
| | | | NaPS, | | | | | |
| | | | seed | | | | | |
| | | | polym. temp. | | | | | |
| | | | 75° C. | | | | | |
| 44 | 43 + blended | UV activated | | after 60 sec | after 60 sec | 70/90 | 90% | 70% |
| | with 1% | with 2% | | AD: no | AD: no | | | |
| | Laromer | Irgacure | | detachment | detachment | | | |
| | LR 8863 | 500 | | | CD: no | | | |
| | | | | | streak | | | |
| | | | | | formation | | | |
| 45 | 43 + blended | UV activated | | after 60 sec | after 60 sec | 70/90 | 100% | 90% |
| | with 2% | with 4% | | AD: no | AD: no | | | |
| | Laromer | Irgacure | | detachment | detachment | | | |
| | LR 8863 | 500 | | | CD: no | | | |
| | | | | | streak | | | |
| | | | | | formation | | | |
| 46 | 43 + blended | UV activated | | after 60 sec | after 60 sec | 70/90 | 100% | 100% |
| | with 3% | with 6% | | AD: no | AD: no | | | |
| | Laromer | Irgacure | | detachment | detachment | | | |
| | LR 8863 | 500 | | | CD: no | | | |
| | | | | | streak | | | |
| | | | | | formation | | | |

### Examples 47 to 50

### Dispersion Particles with Epoxide Groups on the Surface, which are Induced to Crosslink in an Interparticulate Manner by a UV-Activable Cationic Initiator

Imagewise illumination for structuring of the photonic crystal and for producing an inverse photonic crystal is thus also possible.

UV Crosslinking, Cationic

| | | | Analogous to | | | | | |
|---|---|---|---|---|---|---|---|---|
| | | | example 3 | | | | | |
| | | | apart from | | | | | Ormorcer |
| | Sample | | composition | | | Laser | Isopropanol | isopropanol |
| Example | from ex. | Morphology | for 3rd stage | Water | Isopropanol | diffraction | 3 h | 1 day |
| 47 | | | 90 pphm | after approx. | after approx. | 70/90 | 0% | 0% |
| | | | styrene, | 60 sec | 60 sec AD: | | | |
| | | | 10 pphm | AD: no | detachment | | | |
| | | | glycidyl | detachment | approx. 10 mm² | | | |
| | | | methacrylate | | | | | |
| | | | (GMA), | | | | | |
| | | | 0.25 pphm | | | | | |
| | | | Texapon NSO, | | | | | |
| | | | 0.75 pphm | | | | | |
| | | | NaPS, seed | | | | | |
| | | | polym. temp. | | | | | |
| | | | 75° C. | | | | | |
| 48 | 47 | 2 min UV | | after 60 sec | after 60 sec | 70/90 | 90% | 70% |
| | | illuminated | | AD: no | AD: no | | | |
| | | with 2% BB | | detachment | detachment | | | |
| | | | | | CD: no | | | |
| | | | | | streak | | | |
| | | | | | formation | | | |
| 49 | 47 | 2 min UV | | after 60 sec | after 60 sec | 70/90 | 100% | 90% |
| | | illuminated | | AD: no | AD: no | | | |
| | | with 4% AA | | detachment | detachment | | | |
| | | | | | CD: no | | | |
| | | | | | streak | | | |
| | | | | | formation | | | |
| 50 | 47 | 2 min UV | | after 60 sec | after 60 sec | 70/90 | 100% | 100% |
| | | illuminated | | AD: no | AD: no | | | |
| | | with 6% AA | | detachment | detachment | | | |
| | | | | | CD: no | | | |
| | | | | | streak | | | |
| | | | | | formation | | | |

Glycidyl methacrylate is bound in the particle and constitutes a UV-active acid donor.

Description of the Diazonium Salts as UV Catalysts

The ring-opening reaction of epoxides proceeds with the aid of Lewis acids in the course of illumination of diazonium salts.

(Rabek, J. F. (1987), Mechanism of Photophysical and Photochemical Reaction in Polymer: Theory and Practical Applications, Wiley, New York) or

(Crivello J. V., (1984), Adv. In Polymer Sci., 62,1.)

The efficacy of the diazonium salts depends on the substitution on the vinyl ring. This substitution also influences the sensitivity, as does the nature of the anion (BF₄⁻, PF₆⁻, FeCl₄⁻, AsF₆⁻, SbF₆⁻, . . . ,).

The sensitization of the decomposition of diazonium salts in the presence of various electron donors, for example ketones, dyes and hydrocarbons, has been described. (Timpe H. J., (1986), Photopolymere: Prinzipien and Anwendungen. Die Sitzungsberichte der Akademie der Wissenschaften der DDR, 13N, 1, Leipzig.)

Description of the Onium Salts as UV Catalysts

For the interparticulate crosslinking of dispersion particles described here, the onium salts and the organometallic complexes such as ferrocenium salts are also suitable (Fouassier J.-P. (Ed.), “Photoinitiation, Photopolymerization and Photocuring—Fundamental and Applications”, Hanser Publisher, Munich, (1995), chapter 4).

The iodonium and sulfonium compounds are very effective photoinitiators, since they produce Brønsted acids as initiating species.

The compounds used are the diaryl or triaryl onium salts and their corresponding long-chain alkyl derivatives, for example Ciba Irgacure 500, a mixture of benzophenone and 1-hydroxycyclohexyl phenyl ketone (50:50).

For interparticulate UV crosslinking in the case of photonic crystals, particularly suitable are the dialkylphenacylsulfonium salts such as (dodecylmethylphenacyl)sulfonium hexafluoroantimonate (AA) or (p-(decylphenol)phenyl)iodonium hexafluoroantimonate (BB).

(Crivello J. V., et. al., RadTech North America, UV&EB Technology, Charlotte, N.C., May 2004, Technical Conference Proceedings 2004)

These latter two UV initiators, (AA) and (BB), were used as specified in examples 48 to 53.

### Examples 51 to 53

### Dispersion Particles with t-butyl acrylate (t-BA) Groups on the Surface (Analogous to Example 32) and Dissolved Aqueously in the Serum with UV-Activable Acid Donor for the Catalytic Degradation of the t-butyl acrylate to acrylic acid

A suitable UV-activable acid donor for the crosslinking are the same compounds which have already been described as UV-activable cationic initiators above as onium salts, since they can serve not only as a latent source of cationic free radicals but also as a source of a Brønsted acid on UV illumination. This photochemically generated acid is capable of catalyzing the decomposition of the tert-butyl acrylate to acrylic acid and isobutene. A comparative experiment is example 32, in which dispersion particles with tert-butyl acrylate on the surface were produced. In this case, though stirring is not effected at 95° C. for 5 h as stated in example 33 in order to prepare acrylic acid from t-BA actually in the aqueous dispersion on the particle surface, but rather example 32 is used directly without further heat treatment for examples 51 to 53 cited below. The acrylic acid on the surface is thus not generated actually in the course of production of the dispersion, but rather only in the photonic crystal on the surface of the individual particles. After full-surface illumination or imagewise illumination with a UV laser, it is possible to generate the acrylic acid catalytically under relatively mild thermal conditions at 70° C. for 15 minutes on the surface of the particles in the photonic crystal in the presence of the above-described UV catalysts. When the photonic crystal is subsequently contacted with water under alkaline conditions at about pH 9, the illuminated dispersion particles are leached out of the photonic crystal. This gives rise to the desired three-dimensional structuring, characterized by cavities (defect lines) in the photonic crystal. This crystal serves, for example, as a template, i.e. the cavities between the particles (which have not been illuminated) and the defect lines which have arisen through illumination and washing-out of entire dispersion particles can be filled with inorganic materials such as titanium dioxide or silicon, which have a very high refractive index. After the organic dispersion particles have been burnt out, what remains is an inorganic three-dimensionally structured inverse photonic crystal, which can be used an optical component or optical semiconductor entirely in analogy to the electrical semiconductor, for example, to produce an optical computer. Parts of polymer particles may also be burnt out or solubilized or crosslinked.

In other words, it is important for the three-dimensional structuring of the photonic crystal that three-dimensional imagewise illumination of the photonic crystal and hence the production of a three-dimensional structured inverse photonic crystal are also possible.

UV-catalytic Degradation of t-butyl acrylate to acrylic acid

| | | | Analogous to | | | | | |
|---|---|---|---|---|---|---|---|---|
| | | | example 3 | | | | | |
| | | | apart from | | | | | Ormorcer |
| | Sample | | composition | | | Laser | Isopropanol | isopropanol |
| Example | from ex. | Morphology | for 3rd stage | Water | Isopropanol | diffraction | 3 h | 1 day |
| 51 | 32 | UV activated | | after 60 sec | after 60 sec | 30/90 | 90% | 70% |
| | | with 4% BB and | | AD: no | AD: no | | | |
| | | UV-illuminated | | detachment | detachment | | | |
| | | for 5 min, and | | | CD: no | | | |
| | | heat-treated at | | | streak | | | |
| | | 70° C. for 15 min | | | formation | | | |
| 52 | 32 | UV activated | | after 60 sec | after 60 sec | 30/90 | 100% | 80% |
| | | with 4% AA and | | AD: no | AD: no | | | |
| | | UV-illuminated | | detachment | detachment | | | |
| | | for 5 min, and | | | CD: no | | | |
| | | heat-treated at | | | streak | | | |
| | | 70° C. for 15 min | | | formation | | | |
| 53 | 32 | UV activated | | after 60 sec | after 60 sec | 30/90 | 100% | 100% |
| | | with 6% AA and | | AD: no | AD: no | | | |
| | | UV-illuminated | | detachment | detachment | | | |
| | | for 5 min, and | | | CD: no | | | |
| | | heat-treated at | | | streak | | | |
| | | 70° C. for 15 min | | | formation | | | |

The photonic crystal produced from the dispersion by drying comprises cavities between the spherical particles. These are filled isorefractively with the aqueously dissolved initiator, i.e. the refractive index of the particles and the refractive index of the interstices filled with the solution is identical. It is thus possible without any disruption to illuminate the crystal imagewise in a three-dimensional manner (if appropriate holographically or in a two-photon process). The UV illumination (5 minutes continuously or, for example, with a pulsed UV laser) and the thermal aftertreatment (5 minutes at 70° C.) cause the dispersion particles to be soluble only at the illuminated sites, since t-butyl acrylate is decomposed to acrylic acid. These illuminated regions can then be leached out with an aqueous NaOH solution (pH 9), such that cavities between the particles and at the illuminated one-, two- or three-dimensional spaces form after the drying and the removal of the liquid. These spaces are now distributed imagewise in the photonic crystal, corresponding to the imagewise illumination. All empty spaces can now be filled with high-refractive index materials, for example TiO₂ or silicon, so as to form an inverse one-, two- or three-dimensionally structured photonic crystal.

1. A method comprising producing a photonic crystal from polymer particles, wherein the polymer particles do not film and have, at contact points in the photonic crystal, linkage sites which allow linkage of the particles by physical or chemical bonding, without reducing a volume of an interstitial phase by more than 30%.

2. The method according to claim 1, wherein the particles are linked by chemical covalent bonding, ionic or polar bonding, hydrogen bonding, van der Weals bonding or interdiffusion.

3. The method according to claim 1, wherein the polymer particles have a weight-average particle size of >600 nm.

4. The method according to claim 1, wherein a polydispersity index, as a measure of a uniformity of the polymer particles, is <0.15, where the polydispersity index is obtained by formula, polydispersity index, p.i.=(D90−D10)/D50 wherein D90, D10 and D50 are particle diameters wherein:
D90 wherein 90% by weight of the total mass of all particles has a particle diameter ≦D90;
D50 wherein 50% by weight of the total mass of all particles has a particle diameter ≦D50; and
D10 wherein 10% by weight of the total mass of all particles has a particle diameter ≦D10.

5. The method according to claim 1, wherein the polymer particles, at least at the contact points, have one or more polymers attached by polymerization on at least one surface of the polymer particles wherein the polymers of the polymer particles, diffuse into one another and glass transition temperatures of the polymers are below a crystallization temperature of the photonic crystal.

6. The method according to claim 1, wherein the polymer particles have, at least at the contact points on at least one surface of the polymer particles, one or more polar groups or groups suitable for forming hydrogen bonds, wherein the groups enable linkage in the course of crystallization of the photonic crystal.

7. The method according to claim 1, wherein the chemical covalent bonding is achieved by a processing comprising covalently bonding the polymer particles having, at least at the contact points, chemical groups which are bonded to the polymer particle and are capable of being covalently bonded to one another at ambient temperature thermally, by redox reaction, photochemically, and optionally at least one of photoactivable initiators or catalysts and an additional crosslinker.

8. The method according to claim 1, wherein the polymer particles have, at least at the contact points, one or more chemical groups which are bonded to the polymer and are capable of entering into ionic, polar, van der Waals or hydrogen bonds with one another or via an additional crosslinker.

9. The method according to claim 1, wherein the polymer particles, at least in the core, consist of monovalent hydrocarbon monomers to an extent of more than 70% by weight and crosslinking monomers to an extent of from 0 to 30% by weight.

10. The method according to claim 9, wherein the polymer particles consist of styrene to an extent of more than 90% by weight and the crosslinker is divinylbenzene.

11. A photonic crystal obtained by the method according to claim 1.

12. The photonic crystal according to claim 11, wherein the particles have a particle separation, based on the center of the particles, of >600 nm.

13. The photonic crystal according to claim 11, wherein the photonic crystal has at least one edge length of >200 μm.

14. A process for producing structured or unstructured photonic crystals according to claim 11, wherein the photonic crystals are formed from an aqueous dispersion of the polymer particles by volatilization of the water.

15. An optical component comprising the photonic crystals according to claim 11.
